(19) United States
(12) Patent Application Publication
(10) Pub. No.: US 2008/0226317 A1
(43) Pub. Date: Sep. 18, 2008

(54) Image Forming Apparatus and Method

(75) Inventor: Yoshio NAKAZAWA, Chino-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/042,241

(22) Filed: Mar. 4, 2008

(30) Foreign Application Priority Data
Mar. 12, 2007 (JP) 2007-062431
Mar. 12, 2007 (JP) 2007-062432

(51) Int. Cl. G03G 15/02

(52) U.S. Cl. 399/50

(57) ABSTRACT

An image forming apparatus, includes: a plurality of image forming stations each of which includes a photosensitive member and a charger that charges a surface of the photosensitive member to a specified surface potential, and is adapted to execute an image forming operation of forming an electrostatic latent image on the photosensitive member charged by the charger and developing the electrostatic latent image with toner to form an image; a plurality of direct-current bias generators that are provided corresponding to the respective plurality of chargers and generate direct-current voltages as direct-current components of charging biases to be given to the chargers; a plurality of series resistors that are provided corresponding to the respective plurality of chargers and electrically connect the plurality of chargers and the direct-current bias generators corresponding to the chargers in a one-to-one relationship; an alternating-current bias generator that generates alternating-current voltages as alternating-current components of the charging biases to be given to the chargers; and a controller that controls the voltage values of the direct-current voltages to be outputted from the respective direct-current bias generators, wherein the direct-current voltage outputted from the direct-current bias generator corresponding to the charger via the series resistor corresponding to the charger and the alternating-current voltage outputted from the alternating-current bias generator are superimposed and applied as the charging bias to each of the plurality of chargers, and the controller sets the voltage value of the direct-current voltage outputted from the direct-current bias generator to the sum of a target voltage preset as a voltage to be applied to the charger corresponding to the direct-current bias generator and a voltage drop caused by the series resistor corresponding to the charger and calculated based on a detection result on a direct current flowing into the charger for each of the direct-current bias generators.

### CROSS REFERENCE TO RELATED APPLICATION

The disclosure of Japanese Patent Applications No. 2007-062431 and No. 2007-062432 filed on Mar. 12, 2007 including specification, drawings and claims is incorporated herein by reference in its entirety.

### BACKGROUND

1. Technical Field

The invention relates to a technology for giving charging biases generated by superimposing direct-current voltages and alternating-current voltages to chargers in an image forming apparatus and method including a plurality of image forming stations each having a photosensitive member and a charger for charging the photosensitive member to a specified surface potential.

2. Related Art

In some of image forming apparatuses which charges a photosensitive member surface to a specified surface potential, forms an electrostatic latent image, and develops the electrostatic latent image to form an image, a charging bias generated by superimposing a direct-current voltage and an alternating-current voltage is applied to a charger for charging the photosensitive member to efficiently charge the photosensitive member surface. For example, in an image forming apparatus disclosed in JP-A-2006-220955, four direct-current voltages and two alternating-current voltages are generated for four toner image forming units corresponding to four toner colors of yellow (Y), magenta (M), cyan (C) and black (K). A bias generated by superimposing one alternating-current voltage on one direct-current voltage out of these direct-current voltages and alternating-current voltages is fed to the K toner image forming unit, whereas biases generated by superimposing another alternating-current voltage on the respective three direct-current voltages are fed to the Y, M and C toner image forming units.

The apparatus construction can be simplified by sharing a bias generating circuit by a plurality of units as in the above related art. However, in this case, measures need to be taken to prevent the interference of the respective units. As such measures, it can be, for example, thought to connect direct-current voltage generators corresponding to the respective units with an alternating-current voltage generator via series resistors having relatively high resistances. However, this might lead to a likelihood that voltage losses caused by the series resistors occur due to direct currents flowing into the chargers and desired bias voltages cannot be applied to photosensitive members. This problem is not considered in JP-A-2006-220955 at all and there has been room for improvement in the above related art on this point. It is known that the magnitude of a charging current flowing from the charger to the photosensitive member largely varies with time according to the degree of the deterioration of the photosensitive member. No disclosure is made on this point in JP-A-2006-220955, either.

### SUMMARY

An advantage of some aspects of the invention is to provide a technology capable of stably applying proper bias voltages to chargers with a simple apparatus construction in an image forming apparatus and method which includes a plurality of image forming stations each having a photosensitive member and a charger for charging the photosensitive member to a specified surface potential and in which charging biases generated by superimposing direct-current voltages and alternating-current voltages are given to the chargers.

According to image forming apparatus and method of the invention, a plurality of photosensitive members are respectively charged to specified surface potentials by chargers corresponding to the respective plurality of photosensitive members, electrostatic latent images are formed, and the respective electrostatic latent images are developed with toner to form images. A plurality of direct-current bias generators that generate direct-current voltages are provided corresponding to the plurality of chargers. The direct-current voltages from the respective direct-current bias generators are superimposed on an alternating-current voltage from an alternating-current bias generator that generates alternating-current voltage via series resistors and are applied to the respective chargers as charging biases. The voltage values of the direct-current voltages outputted by the respective direct-current bias generators are set as follows.

According to a first aspect of the invention, the voltage value of the direct-current voltage outputted by each direct-current bias generator is set to a sum of a target voltage preset as a voltage to be applied to the charger corresponding to the direct-current bias generator and a voltage drop caused by the series resistor corresponding to the charger and calculated based on a detection result on a direct current flowing into the charger.

According to such a construction, the alternating-current voltage outputted from the alternating-current bias generator is superimposed on the respective direct-current voltages from the plurality of direct-current bias generators and is applied to the chargers corresponding to the respective direct-current bias generators. Thus, the alternating-current bias generator can be shared between the plurality of chargers, wherefore the apparatus construction can be simplified to promote the miniaturization and cost reduction. In this case, since the output voltages from the respective direct-current bias generators are superimposed on the output voltage from the alternating-current bias generator via the series resistors, interferences between the respective direct-current bias generators and those of the direct-current bias generators with the alternating-current bias generator can be suppressed. Further, voltage drops caused by the series resistors are compensated for by causing the direct-current bias generators to output the sum voltages of the target voltages and the voltage drops estimated based on the detection result on the direct currents flowing into the chargers. As a result, suitable bias voltages can be stably applied to the respective chargers despite the simple apparatus construction according to the invention.

According to a second aspect of the invention, a voltage value of the direct-current voltage outputted from each direct-current bias generator is set to a sum of a target voltage preset as a voltage to be applied to the charger corresponding to the direct-current bias generator and a voltage equivalent to a voltage drop caused in the series resistor corresponding to the charger due to a direct current flowing into the charger. Further, the voltage value equivalent to the voltage drop is corrected according to an operation history of the photosensitive member to be charged by the charger corresponding to this direct-current bias generator.

According to such a construction, the alternating-current voltage outputted from the alternating-current bias generator is superimposed on the respective direct-current voltages from the plurality of direct-current bias generators and applied to the chargers corresponding to the respective direct-current bias generators. Thus, the alternating-current bias generator can be shared between the plurality of chargers, wherefore the apparatus construction can be simplified to promote the miniaturization and cost reduction. In this case, since the output voltages from the respective direct-current bias generators are superimposed on the output voltage from the alternating-current bias generator via the series resistors, interferences between the respective direct-current bias generators and those of the direct-current bias generators with the alternating-current bias generator can be suppressed. Further, since the voltage corresponding to the voltage drop by the series resistor is added to the direct-current voltage generated by each direct-current bias generator, each charger is not affected by the voltage drop caused by the series resistor and a suitable charging bias is applied thereto. Furthermore, since the voltage drop by the series resistor is corrected according to the operation history of each photosensitive member, even if the current flowing into the charger varies as a result of a change with time in the characteristics of the photosensitive member due to its operation, the variation of the charging bias due to its influence can be prevented.

The above image forming apparatus may further comprise, in addition to the plurality of image forming stations, a single-operating image forming station that includes a single-operating photosensitive member and a single-operating charger for charging a surface of the single-operating photosensitive member to a specified surface potential, and is adapted to execute a single image forming operation of forming an electrostatic latent image on the surface of the single-operating photosensitive member charged by the single-operating charger and developing the electrostatic latent image to form a monochromatic image in a state where none of the plurality of image forming stations is operating, and a single-operating bias generator that applies a charging bias generated by superimposing a direct-current voltage and an alternating-current voltage to the single-operating charger.

In the construction as above, a monochromatic image can be formed by executing the single image forming operation through the operation of only the single-operating image forming station. By independently providing the single-operating bias generator for giving a charging bias to the single-operating charger provided in the single-operating image forming station, the application of the charging biases to the other image forming stations can be stopped upon executing the single image forming operation.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a diagram showing a first embodiment of an image forming apparatus according to the invention.

FIG. 2 is a diagram showing a construction of a main part of an image forming station in the image forming apparatus of FIG. 1.

FIG. 3 is a diagram showing the construction of a charger.

FIGS. 4A and 4B are diagrams showing primary transfer positions.

FIG. 5 is a diagram showing an electrical construction of the chargers.

FIG. 6 is a diagram showing a circuit example of a direct-current voltage generator.

FIG. 7 is a flow chart showing a setting process of controlling an output voltage of the direct-current voltage generator.

FIG. 8 is a timing chart showing execution timings of the setting processes.

FIG. 9 is a diagram showing an electrical construction of chargers in the second embodiment.

FIG. 10 is a diagram showing a circuit example of a direct-current voltage generator in the second embodiment.

FIG. 11 is a flow chart showing an operation when an image formation command is given.

FIGS. 12A and 12B are charts showing examples of look-up tables.

### DESCRIPTION OF EXEMPLARY EMBODIMENTS

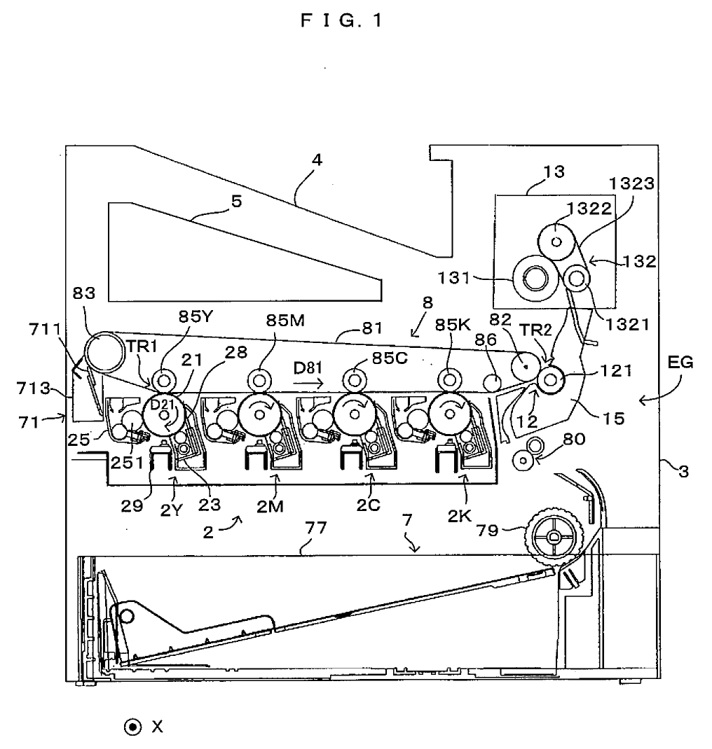

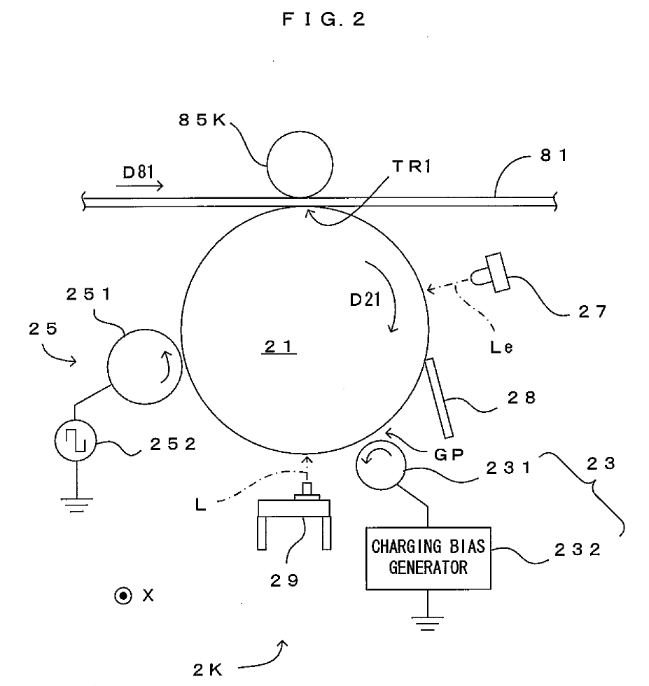

FIG. 1 is a diagram showing a first embodiment of an image forming apparatus according to the invention, and FIG. 2 is a diagram showing a construction of a main part of an image forming station in the image forming apparatus of FIG. 1. This apparatus is an image forming apparatus capable of selectively executing a color mode for forming a color image by superimposing four colors of toners of yellow (Y), magenta (M), cyan (C) and black (K) and a monochromatic mode for forming a monochromatic image using only the toner of black (K). In this image forming apparatus, when an image forming command is given from an external apparatus such as a host computer to a main controller including a CPU, a memory and the like, the main controller feeds a control signal to an engine controller. The engine controller controls the respective parts of the apparatus such as an engine unit EG in accordance with the control signal to perform a specified image forming operation, thereby forming an image corresponding to the image forming command to a sheet as a recording material such as a copy paper, a transfer paper, a sheet or a transparent sheet for OHP.

An electrical component box 5 having a power supply circuit board, a controller board and the like built therein is disposed in a housing main body 3 of the image forming apparatus according to this embodiment. An image forming unit 2, a transfer belt unit 8 and a sheet feeding unit 7 are also arranged in the housing main body 3. Further, a secondary transfer unit 12, a fixing unit 13 and a sheet guiding member 15 are arranged in the inner right side of the housing main body 3 in FIG. 1. It should be noted that the sheet feeding unit 7 is detachably mountable into the housing main body 3. Each of the sheet feeding unit 7 and the transfer belt unit 8 can be detached for repair or exchange.

The image forming unit 2 includes four image forming stations 2Y (for yellow), 2M (for magenta), 2C (for cyan) and 2K (for black). In FIG. 1, since the respective image forming stations of the image forming unit 2 are identically constructed, the construction of only one of the image forming stations is identified by reference numerals to simplify the graphical representation and those of the other image forming stations are not identified by reference numerals.

Each of the image forming stations 2Y, 2M, 2C and 2K includes a drum-shaped photosensitive member 21, on the outer surface of which a toner image of a corresponding color is to be formed. Each photosensitive member 21 is connected to a special driving motor (not shown) to be drivingly rotated at a specified speed in a direction of an arrow D21 in FIG. 1. Further, a charger 23, a line head 29, a developer 25, a static eliminating light source 27 and a photosensitive member cleaner 28 are arranged around the photosensitive member 21 in a rotating direction of the photosensitive member 21. A charging operation, a latent image forming operation and a toner developing operation are performed by these functional sections. At the time of executing the color mode, a color image is formed by superimposing toner images formed by all the image forming stations 2Y, 2M, 2C and 2K on a transfer belt 81 provided in the transfer belt unit 8. Further, at the time of executing the monochromatic mode, only the image forming station 2K is operated to form a black monochromatic image.

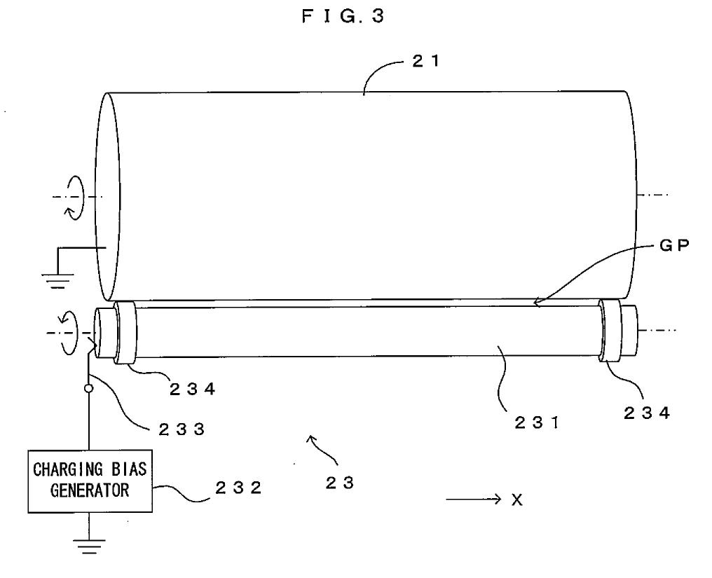

FIG. 3 is a diagram showing the construction of the charger. The charger 23 includes a charging roller 231 having the outer surface thereof made of a metal material such as iron, aluminum or stainless steel. Rollers 234 made of an insulating material are mounted at the opposite ends of this charging roller 231. A specific gap GP is defined between the charging roller 231 and the outer surface of the photosensitive member 21 by the contact of the rollers 234 with the outer surface of the photosensitive member 21. One end of a sliding terminal 233 made of an elastic and electrically conductive plate material such as stainless steel or phosphor bronze is slidably connected with an end face of the charging roller 231. The other end of the sliding terminal 233 is connected with a charging bias generator 232. A charging bias voltage from the charging bias generator 232 is applied to the charging roller 231 via the sliding terminal 233. Thus, the outer surface of the photosensitive member 21 is charged to a specified surface potential.

Referring back to FIG. 1, the construction of the apparatus is further described. The line head 29 includes a plurality of light emitting elements arrayed in the axial direction of the photosensitive member 21 (direction X normal to the plane of FIG. 1), and is arranged to face the photosensitive member 21. Light beams L are emitted from these light emitting elements toward the outer surface of the photosensitive member 21 charged by the charger 23 to form an electrostatic latent image on this outer surface.

The developer 25 includes a developing roller 251 carrying toner on the outer surface thereof. A development bias is applied from a development bias generator 252 electrically connected with the developing roller 251 to the developing roller 251. By the development bias, the charged toner moves from the developing roller 251 to the photosensitive member 21 at a developing position where the developing roller 251 and the photosensitive member 21 are in contact, whereby the electrostatic latent image formed on the outer surface of the photosensitive member 21 is developed.

The toner images developed at the developing positions are conveyed in rotating directions D21 of the photosensitive members 21. Subsequently, the toner images are primarily transferred to the transfer belt 81 at primary transfer positions TR1 to be described in detail later where the transfer belt 81 and the respective photosensitive members 21 are in contact.

Further, the static eliminating light source 27 faced toward the photosensitive member 21 and the photosensitive member cleaner 28 held in contact with the outer surface of the photosensitive member 21 are arranged in this order at a side downstream of the primary transfer position TR1 and upstream of the charger 23 in the rotating direction D21 of each photosensitive member 21. The static eliminating light source 27 resets the surface potential of the photosensitive member 21 by irradiating a static eliminating light beam Le to the outer surface of the photosensitive member 21 after the primary transfer. The photosensitive member cleaner 28 is held in contact with the outer surface of the photosensitive member to remove the toner remaining on the outer surface of the photosensitive member 21 after the primary transfer for cleaning. The outer surface of the photosensitive member 21 having the charge eliminated and toner removed is conveyed again to the position to face the charging roller 231 and charged by the charger 23 for the formation of an electrostatic latent image.

The transfer belt unit 8 includes a drive roller 82, a driven roller (blade facing roller) 83 disposed at the left of the drive roller 82 in FIG. 1, and the transfer belt 81 mounted on these rollers and driven to turn in a direction (conveying direction) of an arrow D81 of FIG. 1 by the drive roller 82. The transfer belt unit 8 also includes four primary transfer rollers 85Y, 85M, 85C and 85K arranged at the inner side of the transfer belt 81 to face the respective photosensitive members 21 of the respective image forming stations 2Y, 2M, 2C and 2K in a one-to-one correspondence when cartridges are mounted. These primary transfer rollers are respectively electrically connected to a primary transfer bias generator (not shown).

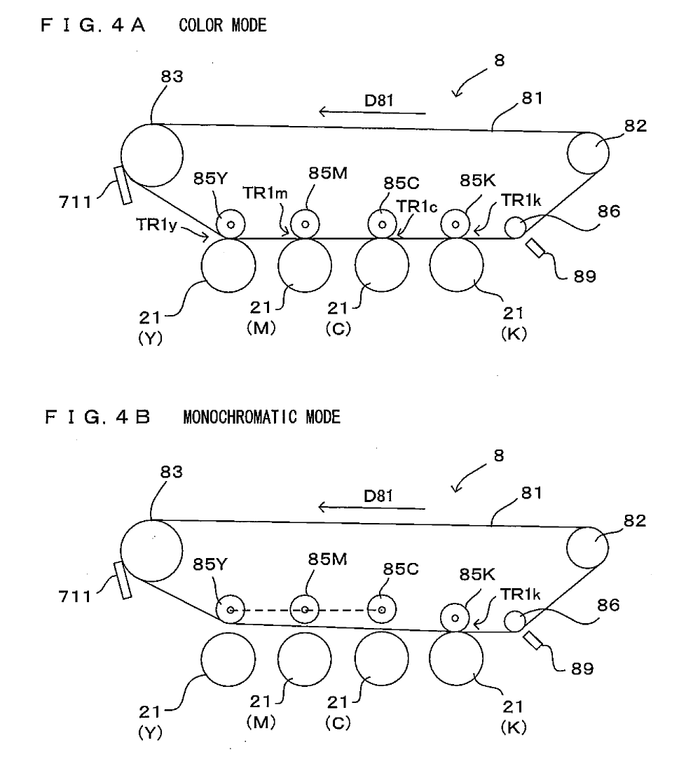

FIGS. 4A and 4B are diagrams showing the primary transfer positions. At the time of executing the color mode, all the primary transfer rollers 85Y, 85M, 85C and 85K are positioned toward the image forming stations 2Y, 2M, 2C and 2K as shown in FIG. 4A. In this way, the transfer belt 81 is pushed to abut on the photosensitive members 21 of the image forming stations 2Y, 2M, 2C and 2K to define the primary transfer positions TR1y, TR1m, TR1c and TR1k between the respective photosensitive members 21 and the transfer belt 81. Primary transfer biases are applied from the primary transfer bias generator to the primary transfer roller 85Y and the like at suitable timings. With this, the toner images formed on the outer surfaces of the respective photosensitive members 21 are transferred to the outer surface of the transfer belt 81 at the corresponding primary transfer positions. In other words, the monochromatic toner images of the respective colors are superimposed one above another on the transfer belt 81 to form a color image in the color mode.

On the other hand, at the time of executing the monochromatic mode, out of the four primary transfer rollers, the primary transfer rollers 85Y, 85M and 85C are separated from the facing image forming stations 2Y, 2M and 2C as shown in FIG. 4B. And only the primary transfer roller 85K corresponding to the black color is held in contact with the image forming station 2K. In this way, only the image forming station 2K for monochromatic printing is held in contact with the transfer belt 81. As a result, the primary transfer position TR1k is defined only between the primary transfer roller 85K and the image forming station 2K. A primary transfer bias is applied from the primary transfer bias generator to the primary transfer roller 85K at a suitable timing. With this, the black toner image formed on the outer surface of the photosensitive member 21 provided in the image forming station 2K is transferred to the outer surface of the transfer belt 81 at the primary transfer position TR1k to form a monochromatic image.

The transfer belt unit 8 further includes a downstream guide roller 86 disposed at downstream of the primary transfer roller 85K for black and upstream of the drive roller 82. This downstream guide roller 86 is arranged in contact with the transfer belt 81 on a tangent line common to the primary transfer roller 85K and the photosensitive member 21(K) for black at the primary transfer position TR1 defined by the contact of the primary transfer roller 85K and the photosensitive member 21 of the image forming station 2K.

A patch sensor 89 is disposed at a position facing the outer surface of the transfer belt 81 mounted on the downstream guide roller 86. The patch sensor 89 is, for example, a reflection-type photosensor, and detects the position and density of a patch image formed on the transfer belt 81 if necessary by optically detecting a change in the reflectivity of the outer surface of the transfer belt 81.

The sheet feeding unit 7 includes a sheet feeder comprised of a sheet cassette 77 capable of accommodating a stack of sheets and a pickup roller 79 for dispensing the sheets one by one from the sheet cassette 77. The sheet dispensed from the sheet feeder by the pickup roller 79 is fed along the sheet guiding member 15 to a secondary transfer position TR2 where the drive roller 82 and a secondary transfer roller 121 are in contact after a sheet feeding timing thereof is adjusted by a pair of registration rollers 80.

The secondary transfer roller 121 is movably structured to abut on and move away from the transfer belt 81, and is driven to abut on and move away from the transfer belt 81 by a secondary transfer roller driving mechanism (not shown). The fixing unit 13 includes a rotatable heating roller 131 having a heating element such as a halogen heater built therein, and a pressing device 132 for pressing and biasing the heating roller 131. The sheet having an image secondarily transferred to the outer surface thereof is guided to a nip portion defined between the heating roller 131 and a pressure belt 1323 of the pressing device 132 by the sheet guiding member 15. The image is thermally fixed onto the sheet at a specified temperature at the nip portion. The pressing device 132 is comprised of two rollers 1321 and 1322 and the pressure belt 1323 mounted on these rollers. A part of the outer surface of the pressure belt stretched between the two rollers 1321 and 1322 is pressed against the outer circumferential surface of the heating roller 131. With this, the nip portion defined between the heating roller 131 and the pressure belt 1323 is formed to be wide. The sheet subjected to a fixing process in this way is conveyed to a discharge tray 4 provided on the top surface of the housing main body 3.

The aforementioned drive roller 82 functions to drivingly turn the transfer belt 81 in the direction of the arrow D81 in FIG. 1 and also functions as a backup roller for the secondary transfer roller 121. A rubber layer having a thickness of about 3 mm and a volume resistivity of 1000 kΩ·cm or below is formed on the outer circumferential surface of the drive roller 82. An electrical conduction path of a secondary transfer bias supplied from an unillustrated secondary transfer bias generator via the secondary transfer roller 121 is formed by a metallic shaft which is grounded. By providing the highly frictional and impact absorbing rubber layer on the drive roller 82 in this way, image deterioration resulting from the transmission of an impact to the transfer belt 81 given upon the arrival of the sheet to the secondary transfer position TR2 can be prevented.

Further, a cleaning device 71 is arranged to face the blade facing roller 83 in this apparatus. The cleaning device 71 includes a cleaner blade 711 and a waste toner box 713. The cleaner blade 711 has the tip thereof held in contact with the blade facing roller 83 via the transfer belt 81, whereby foreign matters such as toner residual on the transfer belt 81 after the secondary transfer and paper powder can be removed. The foreign matters removed in this manner are collected into the waste toner box 713. The cleaner blade 711 and the waste toner box 713 are constructed to be integral to the blade facing roller 83.

In this embodiment, the photosensitive member 21, the charging roller 231, the developer 25, the static eliminating light source 27 and the photosensitive member cleaner 28 of each of the image forming stations 2Y, 2M, 2C and 2K are integrally unitized into a cartridge. These cartridges are detachably mountable into an apparatus main body. Each cartridge includes a nonvolatile memory for storing information on this cartridge. The usage histories and the lives of articles of consumption of the respective cartridges are administered based on these pieces of information.

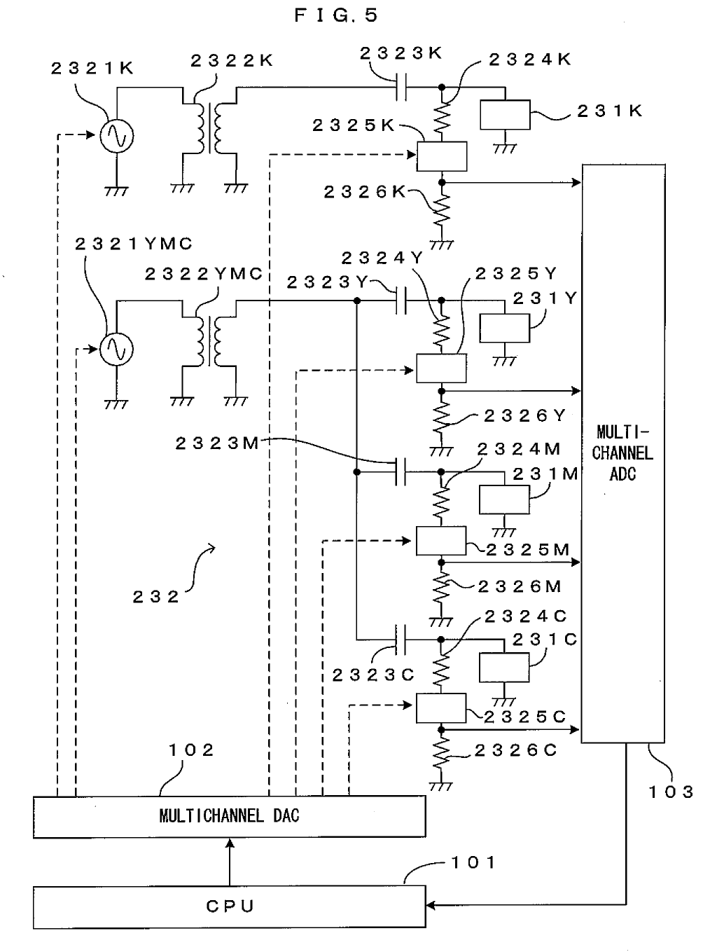

FIG. 5 is a diagram showing an electrical construction of the chargers. In FIG. 5, the four charging rollers 231 corresponding to the toner colors Y, M, C and K are respectively identified by reference numerals 231Y, 231M, 231C and 231K to be distinguished from each other.

The charging bias generator 232 includes alternating-current voltage generators 2321K, 2321YMC and direct-current voltage generators 2325Y, 2325M, 2325C and 2325K controlled by a CPU 101 for controlling the operation of the entire apparatus. More specifically, control signals for determining the values of voltages to be generated by the respective voltage generators are outputted from the CPU 101 to a multichannel DA converter (DAC) 102, which outputs analog voltages corresponding to the control signals to the respective voltage generators. Each of the voltage generators 2321K, 2321YMC, 2325Y, 2325M, 2325C and 2325K outputs an alternating-current voltage or a direct-current voltage having a voltage value corresponding to a reference voltage using the received analog voltage as the reference voltage. The alternating-current voltage generators 2321YMC, etc. can be, for example, constructed by inverters and high-frequency amplifiers for amplifying reference clocks given from the outside. The direct-current voltage generators 2325Y, etc. can be, for example, constructed by DC-DC converters.

Out of these outputted voltages, the alternating-current voltage outputted from the alternating-current voltage generator 2321K is boosted by a transformer 2322K, and the boosted alternating-current voltage is superimposed on the direct-current voltage outputted from the direct-current voltage generator 2325K via a series resistor 2324K. A charging bias voltage generated by superimposing the alternating-current voltage and the direct-current voltage in this way is applied to the charging roller 231K. A capacitor 2323K for direct current cutoff is disposed in a conduction path between a secondary side of the transformer 2322K and a point of superimposition with the direct current voltage.

The direct-current voltage applied to the charging roller 231K is a negative voltage of about (−500) V for instance, and determines the charging potential of the photosensitive member 21. On the other hand, the alternating-current voltage applied to the charging roller 231K is, for example, a sinusoidal alternating-current voltage having a peak-to-peak voltage of about 1500 V and a frequency of about 1 to 2 kHz, and has a function of promoting movements of electric charges to the photosensitive member 21 by causing a discharge in the gap GP between the charging roller 231K and the photosensitive member 21 to efficiently charge the photosensitive member 21 although it is not directly related to the charging potential of the photosensitive member 21.

On the other hand, the alternating-current voltage outputted from the alternating-current voltage generator 2321YMC is inputted to the charging rollers 231Y, 231M and 231C corresponding to the toner colors Y, M and C after being boosted by a transformer 2322YMC. In other words, when viewed from the alternating-current voltage generator 2321YMC, the respective charging rollers 231Y, 231M and 231C are connected in parallel as loads.

More specifically, the alternating-current voltage outputted from the transformer 2322YMC via a capacitor 2323Y for direct current cutoff and the direct-current voltage outputted from the direct-current voltage generator 2325Y via a series resistor 2324Y are superimposed and applied as a charging bias to the charging roller 231Y corresponding to the yellow image forming station 2Y Similarly, a charging bias applied to the charging roller 231M corresponding to the magenta color is generated by superimposing the alternating-current voltage outputted from the transformer 2322YMC via a capacitor 2323M for direct current cutoff and the direct-current voltage outputted from the direct-current voltage generator 2325M via a series resistor 2324M. Further, a charging bias applied to the charging roller 231C corresponding to the cyan color is generated by superimposing the alternating-current voltage outputted from the transformer 2322YMC via a capacitor 2323C for direct current cutoff and the direct-current voltage outputted from the direct-current voltage generator 2325C via a series resistor 2324C.

By connecting the respective charging rollers 231Y, 231M and 231C to the transformer 2322YMC via the capacitors 2323Y, 2323M and 2323C, the influence of the direct-current voltage applied to each charging roller on bias circuits to the other charging rollers can be suppressed. Further, by connecting the series resistors to the respective direct-current voltage generators 2325Y, 2325M and 2325C, the entrance of the alternating-current voltages into the direct-current voltage generators can be prevented.

As described above, in this embodiment, the miniaturization and cost reduction of the apparatus are promoted by sharing the alternating-current voltage generator 2321YMC and the transformer 2322 YMC for three colors of Y, M and C. On the other hand, the direct-current voltage generators 2325Y, 2325M and 2325C are independently provided corresponding to the respective charging rollers, thereby making it possible to individually set the charging biases and to independently set the charging potentials of the photosensitive members 21 for the respective toner colors.

For the charging roller 231K corresponding to the black color singly used in a monochromatic mode, the bias generating circuit independent of those of the other toner colors is provided. By doing so, the application of biases to the charging rollers 231Y, 231M and 231C irrelevant to the operation can be stopped at the time of executing the monochromatic mode. As a result, power consumption in the execution of the monochromatic mode can be reduced and the deterioration of the photosensitive members 21 provided in the respective image forming stations 2Y, 2M and 2C can be suppressed to extend the lives thereof.

Current detecting resistors 2326Y, 2326M, 2326C and 2326K are disposed respectively in series circuits including the corresponding direct-current voltage generators 2325Y, 2325M, 2325C and 2325K and charging rollers 231Y, 231M, 231C and 231K. Voltages in proportion to direct currents flowing into the charging rollers 231Y, 231M, 231C and 231K are generated between terminals of the current detecting resistors 2326Y, 2326M, 2326C and 2326K. These voltages are respectively inputted to a multichannel AD converter (ADC) 103. The multichannel ADC 103 converts the received analog voltage values into digital values and outputs them to the CPU 101, whereby the CPU 101 can individually detect the direct currents flowing into the respective charging rollers 231Y, 231M, 231C and 231K in this embodiment. The CPU 101 controls the values of the direct-current voltages outputted from the respective direct-current voltage generators 2325Y, 2325M, 2325C and 2325K by setting values of control signals to be fed to the multichannel DAC 102 based on the values of the currents flowing into the respective charging rollers thus obtained.

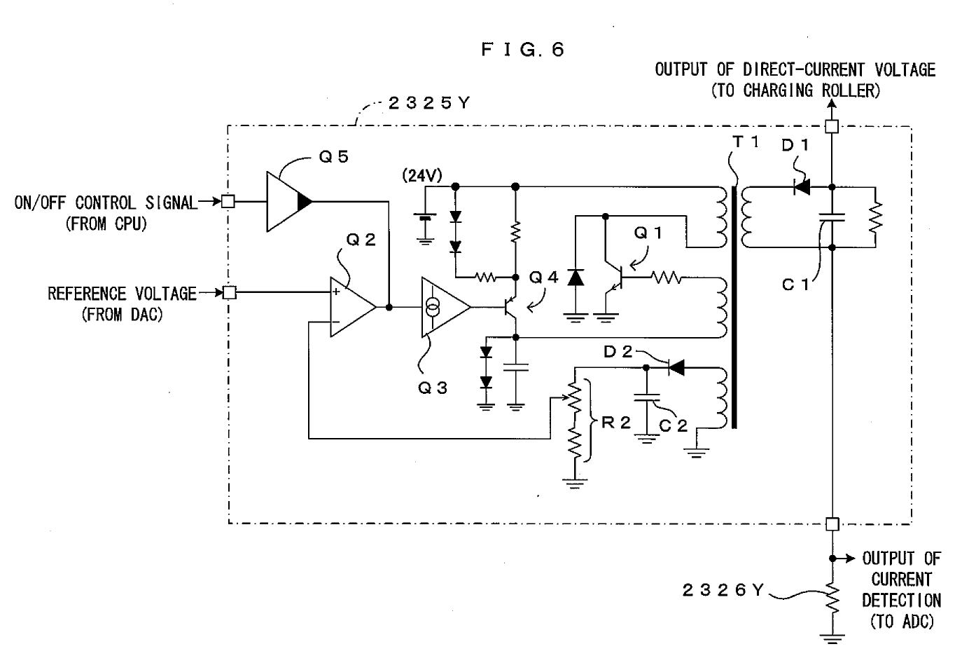

FIG. 6 is a diagram showing a circuit example of the direct-current voltage generator. The above-described direct-current voltage generators 2325Y, etc. are, for example, constructed by DC-DC converters as shown in FIG. 6. Here, the construction is described, taking the yellow direct-current voltage generator 2325Y as an example. The direct-current voltage generators 2325M, 2325C and 2325K corresponding to the other toner colors have the same construction. Since the circuit construction of the DC-DC converter shown in FIG. 6 itself is known, the summary of the construction and operation thereof is briefly described here.

In the direct-current voltage generator 2325Y, a transistor Q1 and a transformer T1 construct a self-oscillator. An alternating-current voltage having appeared at one end of a secondary winding of the transformer T1 is rectified by a diode D1 and a capacitor C1 to be outputted as a direct-current voltage. In this way, a direct-current voltage of 24 V is, for example, boosted to a specified high voltage (−500 V for instance). This direct-current high voltage is applied as a direct-current component of a charging bias to the charging roller 231Y via the series resistor 2324Y as described above. As shown in FIG. 6, the direction of the rectifying diode D1 is set to give a negative voltage to the charging roller 231Y Therefore, the photosensitive member 21 is charged to a negative potential.

A voltage taken out from another winding of the transformer T1 and in proportion to an output voltage is rectified by a diode D2 and a capacitor C2 and is suitably voltage-divided by a resistor R2 to be inputted as a return signal to an error amplifier Q2. A reference voltage outputted from the multichannel DAC 102 in accordance with a control signal from the CPU 101 is fed to the error amplifier Q2, and the error amplifier Q2 outputs an error signal after comparing this reference voltage and the return signal. This error signal increases or decreases an injected power to a base of the transistor Q1 via a current amplifier Q3 and a driver transistor Q4, whereby the output voltage is subjected to a constant voltage control to become a voltage in proportion to the reference voltage.

The current detecting resistor 2326Y is disposed between the other end of the secondary winding of the transformer T1 and a ground potential. A terminal voltage of the current detecting resistor 2326Y is inputted to the AD converter 103. As described above, in the case of constricting the direct-current voltage generators 2325Y, etc. by DC-DC converters, the secondary winding of the transformer T1 for extracting the output voltage is floating relative to the primary side. Thus, a resistor for current detection can be disposed between a ground terminal of the secondary winding opposite to the load side connected with the load (charging roller) and the ground potential. By doing so, the current can be detected almost without influencing the load side. Further, only the direct current flowing into the charging roller 231Y to be controlled can be detected without being influenced by the currents flowing into the other charging rollers and the alternating currents.

A switching element Q5 that operates in accordance with a control signal given from the CPU 101 to switch a high voltage output on and off is provided in the direct-current voltage generator 2325Y. The switching element Q5 is connected to an output of the error amplifier Q2, and forms the above-described return control loop by being set in an open state when a control signal for switching the high voltage output on is fed from the CPU 101, while grounding the output of the error amplifier Q2 to forcibly set a zero potential so that no high voltage is outputted when a control signal for switching the high voltage output off is fed from the CPU 101.

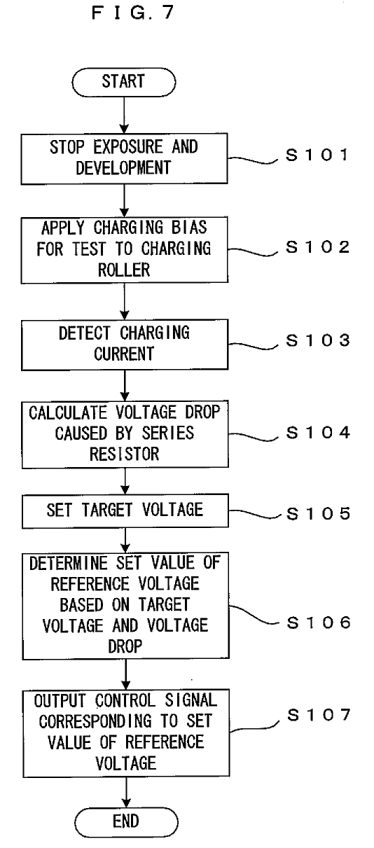

FIG. 7 is a flow chart showing a setting process of controlling the output voltage of the direct-current voltage generator. The CPU 101 executes the setting process shown in FIG. 7 for each toner color to control the value of the direct-current voltage outputted from each of the direct-current voltage generators 2325Y, 2325M, 2325C and 2325K. Here is described the setting process for the charging bias to be applied to the charging roller 231Y corresponding to the toner color Y, but the content of the setting process is the same for the other toner colors.

In this setting process, the exposure by the line head 29 and the development by the developing device 25 stopped (Step S101) to prevent the toner from being uselessly consumed during the process. In this state, a charging bias voltage for test is applied to the charging roller 231Y (Step S102). This charging bias for test preferably has a waveform similar to that of the charging bias used during the image formation in order to execute the setting process on conditions close to those during the image formation. In other words, the charging bias for test applied here is generated by superimposing an alternating-current voltage on a direct-current voltage corresponding to the charging roller 231Y.

The direct current (charging current) flowing into the charging roller 231Y at this time is detected as the terminal voltage of the current detecting resistor 2326Y (Step S103). A voltage value equivalent to a voltage drop caused by the series resistor 2324Y connected to the direct-current voltage generator 2325Y is calculated from the value of the charging current thus detected (Step S104). A voltage value Vdrop equivalent to the voltage drop can be obtained by the following equation:

Vdrop=Vd×Rs/Rd

where Rs denotes the resistance value of the series resistor connected to the direct-current voltage generator 2325Y, Rd the resistance value of the current detecting resistor 2326Y and Vd the detected terminal voltage of the current detecting resistor 2326Y. The resistance value Rd of the current detecting resistor 2326Y is assumed to be such a value that a charging current in a supposed current range can be outputted by being converted into a direct-current voltage of 5 V or below. Specifically, the resistance value Rd of the current detecting resistor 2326Y is preferably sufficiently smaller than the resistance value of the series resistor 2324Y.

In this embodiment, as shown in FIG. 5, the series resistor 2324Y is connected to the direct-current voltage generator 2325Y. When a charging current flows in a direct-current circuit extending from the direct-current voltage generator 2325Y to the charging roller 231Y, a direct-current voltage actually applied to the charging roller 231Y is a difference between the voltage outputted from the direct-current voltage generator 2325Y and a voltage drop by the series resistor 2324Y due to this voltage drop. Generally, the direct current flowing into the charging roller is about 100 μA. If the resistance value of the series resistor is, for example, assumed to be 1 MΩ, the voltage drop is as large as 100 V and cannot be ignored.

Accordingly, in order to apply a desired direct-current voltage to the charging roller 231Y, the voltage outputted from the direct-current voltage generator 2325Y needs to be the sum value of the voltage value to be applied to the charging roller 231Y and the voltage drop. Specifically, the direct-current voltage to be applied to the charging roller 231Y is set as a target voltage (Step S105), and a reference voltage value to be outputted from the multichannel DAC 102 is determined such that the sum voltage of this target voltage and the voltage drop by the series resistor 2324Y is outputted from the direct-current voltage generator 2325Y (Step S106). A control signal corresponding to the set value of this reference voltage is outputted to the multichannel DAC 102 (Step S107), whereby the direct-current voltage, which is the sum of the target voltage and the voltage drop by the series resistor 2324Y, is outputted from the direct-current voltage generator 2325Y As a result, the desired direct-current voltage, that is, the target voltage is applied to the charging roller 231Y.

The multichannel DAC 102 preferably has a function of latching input data, that is, latches a digital value unless being rewritten by the CPU 101 once the digital value corresponding to the reference voltage is given. For this purpose, a general-purpose DA converter for digital tuning can be used. By doing so, an amount of data transmitted from the CPU 101 to the multichannel DAC 102 can be reduced, and the process can be simpler since the CPU 101 needs not constantly monitor the reference voltage.

The above-described charging bias setting process is preferably executed at a timing different from that of an image forming operation. This is because, if the charging bias is changed during the image forming operation, the change of the surface potential of the photosensitive member 21 may influence the image density and image quality. Accordingly, the above setting process is preferably executed when the image forming operation is executed in none of the image forming stations such as immediately after the apparatus is turned on or during a standby period during which no image formation command is given to the apparatus. In order to maintain a good image quality, the charging bias setting process is preferably executed every time a specified number of images are formed or at regular time intervals.

However, the image forming apparatus of this embodiment is a so-called tandem-type color image forming apparatus in which the image forming stations 2Y, 2M, 2C and 2K are arranged in a row in the moving direction of the transfer belt 81. In such an image forming apparatus, the image forming operations by the respective image forming stations can be executed in parallel, but progress at slightly different timings due to positional differences. Thus, in the case of, for example, continuously forming many color images, there may not always exist a timing at which an image is formed in none of the image forming stations, in a more precise sense, at which none of the photosensitive member 21 is charged to form an electrostatic latent image. If all the image forming stations are stopped to execute the setting process in such a case, the throughput of image formation decreases. The following arrangement can be, for example, made to prevent this.

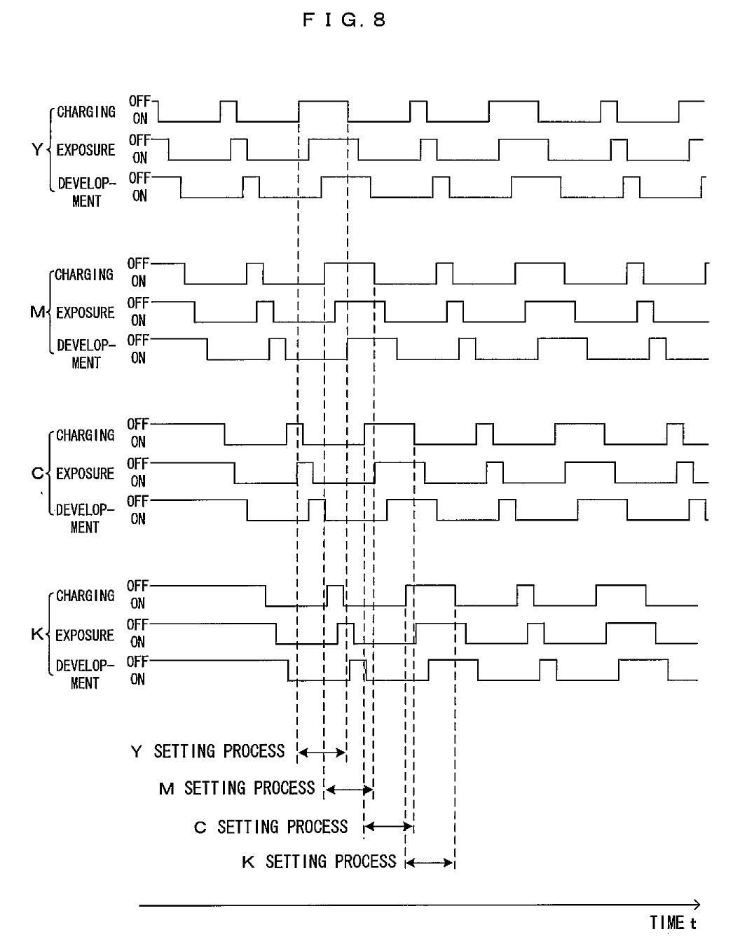

FIG. 8 is a timing chart showing execution timings of the setting processes. FIG. 8 shows the operation timings of the respective parts of the apparatus in the case where two full-color images are continuously formed in a round (images of two pages are formed on the transfer belt 81). As shown in FIG. 8, the timings of the charging operations are slightly shifted from each other in the image forming stations and there may not exist a timing at which the charging operation is executed in none of the image forming stations and the setting process can be executed. In such a case, as shown in FIG. 8, the charging bias setting process for the charging roller can be executed in each of the image forming stations when the charging operation of the charging roller corresponding to the image forming station is not executed.

As a result, the charging bias setting processes for the respective toner colors are started at different timings. In this case, the setting process for one toner color is possibly executed during the execution of the charging operation(s) for the other toner color(s). Accordingly, if the direct-current voltage of the charging bias is changed for the setting process, the charging operation(s) for the other toner color(s) being executed might be affected. However, the charging bias hardly needs to be changed during the continuous use of the apparatus and the variation of the direct-current voltage is not very large, wherefore a possibility of occurrence of such a problem is extremely small.

As described above, in this embodiment, the alternating-current voltage generator 2321YMC for generating alternating-current components of the charging biases to be applied to the charging rollers 231Y, 231M and 231C used only in the color mode is shared by these charging rollers to promote the miniaturization and cost reduction of the apparatus. Further, by individually providing the direct-current voltage generators for generating the direct-current components of the charging biases corresponding to the respective charging rollers, the surface potentials of the photosensitive members 21 can be independently set for the respective toner colors corresponding to the respective charging rollers.

The direct currents flowing into the respective charging rollers 231Y, etc. are detected by the current detecting resistors 2326Y, etc., voltage drops by the series resistors 2324Y, etc. are calculated from the detection results, and the direct-current voltages as the sums of the target voltages and the voltage drops are outputted from the respective direct-current voltage generators 2325Y, etc. Therefore, desired direct-current voltages can be applied to the respective charging rollers 231Y, etc. without being affected by the voltage drops caused by the series resistors.

By independently providing the bias generating circuit for the black color singly used in the monochromatic mode, it is not necessary to charge the other photosensitive members 21 in the execution of the monochromatic mode. Therefore, the lives of the photosensitive members 21 can be extended.

As described above, in this embodiment, the respective image forming stations 2Y, 2M and 2C function as “image forming stations” of the invention. The photosensitive member 21 and the charging roller 231 provided in each image forming station function as a “photosensitive member” and a “charger” of the invention, respectively. Further, the alternating-current voltage generator 2321YMC and the transformer 2322YMC, as a unit, function as an “alternating-current bias generator” of the invention, whereas the direct-current voltage generators 2325Y, 2325M and 2325C respectively function as “direct-current bias generators” of the invention. Further, in this embodiment, the CPU 101 functions as a “controller” of the invention.

Further, in this embodiment, the resistors 2324Y, etc. connected to the respective direct-current voltage generators 2325Y, etc. in series correspond to “series resistors” of the invention, whereas the current detecting resistors 2326Y, etc. correspond to a “current detector” and “current detecting resistors” of the invention. Furthermore, in this embodiment, the transfer belt 81 functions as an “image carrier” of the invention, and the primary transfer positions TR1y, etc. corresponding to the respective image forming stations correspond to “transfer positions” of the invention.

Further, in this embodiment, the black image forming station 2K singly used in the monochromatic mode corresponding to a “single image forming operation” of the invention corresponds to an “image forming station for single operation”, and the photosensitive member 21 and the charging roller 231K provided in this image forming station 2K respectively function as a “photosensitive member for single operation” and a “charger for single operation” of the invention. The alternating-current voltage generator 2321K, the transformer 2322K, the direct-current voltage generator 2325K, etc. for giving a charging bias to the charging roller 231K, as a unit, function as a “bias generator for single operation” of the invention.

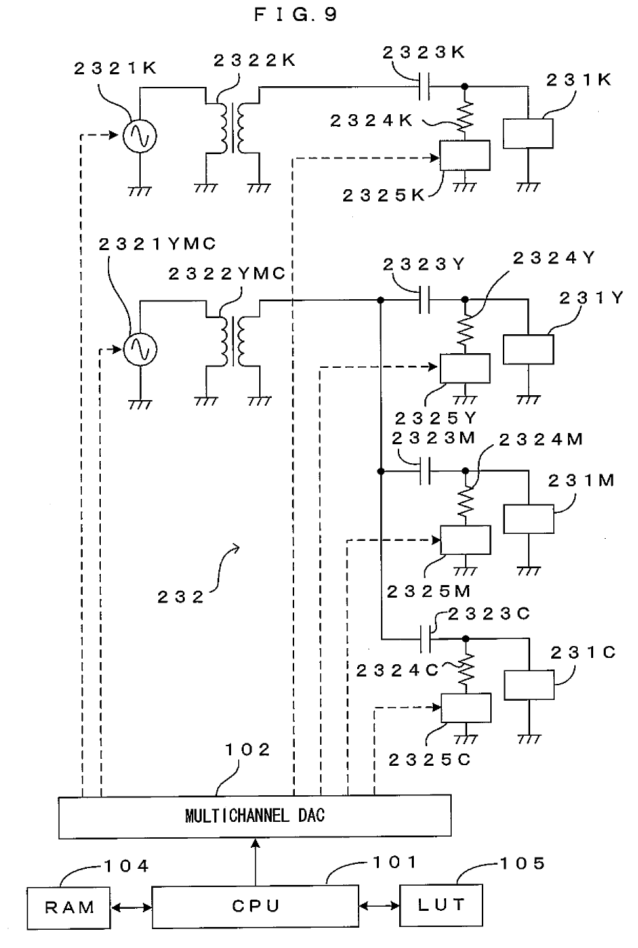

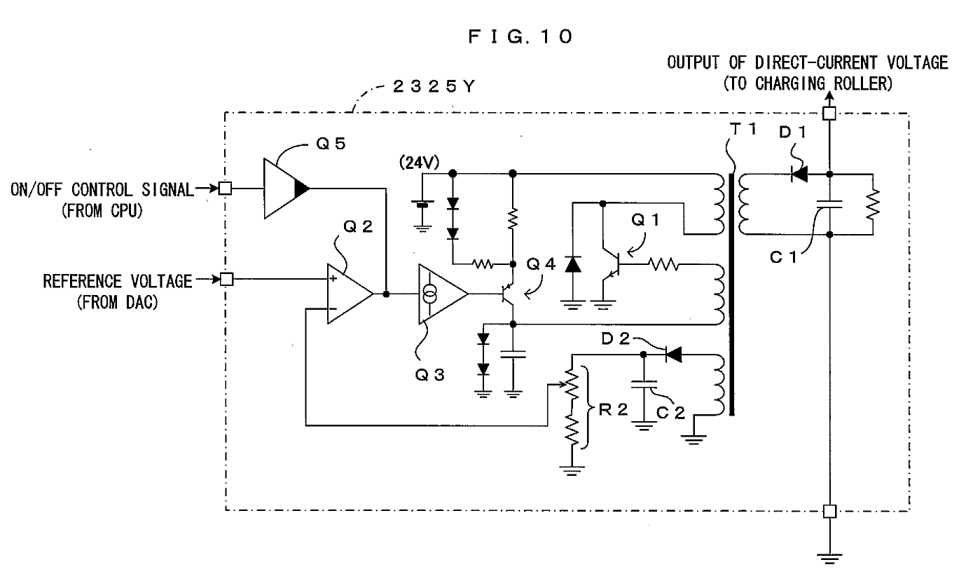

Next, a second embodiment of the image forming apparatus according to the invention is described. FIG. 9 is a diagram showing an electrical construction of chargers in the second embodiment, and FIG. 10 is a diagram showing a circuit example of a direct-current voltage generator in the second embodiment. In this second embodiment, as shown in FIGS. 9 and 10, the current detecting resistors 2326Y, etc. provided in the first embodiment are omitted, and output ends of the respective direct-current voltage generators 2325Y, etc. are directly grounded. Further, in the second embodiment, the multichannel ADC is omitted, whereas a RAM 104 and a look-up table (LUT) 105 are provided anew. Except these points, the construction of the second embodiment is the same as that of the first embodiment. Accordingly, the same construction as in the first embodiment is identified by the same reference numerals and is not described below.

The setting of the output voltages of the respective direct-current voltage generators 2325Y, 2325M, 2325C and 2325K by the CPU 101 is described. In this embodiment, when an image formation command is given from an external apparatus, the CPU 101 controls the respective image forming stations to execute an image forming operation. Prior to that, the values of direct-current voltages to be outputted from the respective direct-current voltage generators 2325Y, etc. are set. In this embodiment, the memory (RAM) 104 for storing information representing the operation histories of the photosensitive members 21 provided in the respective image forming stations and the look-up table (LUT) 105 relating the operation histories of the photosensitive members and the set voltages of the direct-current voltage generators are provided in addition to the CPU 101. The CPU 101 refers to the look-up table 105 based on the information on the operation histories of the photosensitive members 21 stored in the RAM 104 to set the output voltages of the direct-current voltage generators. Specifically, when an image formation command is given from the external apparatus, the CPU 101 performs the following operation. The control of the yellow image forming station 2Y is described below, but the other image forming stations can be similarly controlled.

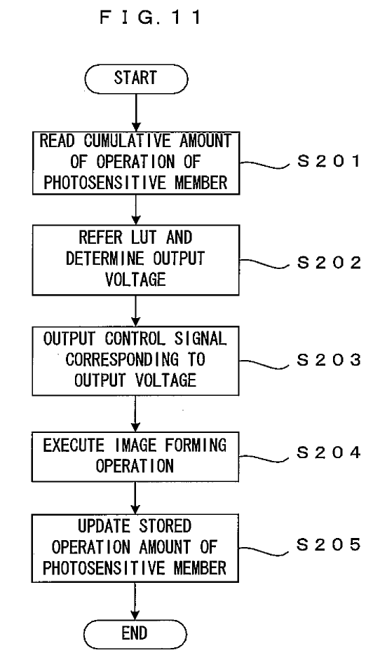

FIG. 11 is a flow chart showing the operation when an image formation command is given. When the image formation command is given, the CPU 101 reads from the RAM 104 the information on the cumulative amount of operation of the photosensitive member 21 of the image forming station 2Y to use which is supposed to execute an image forming operation (Step S201). The cumulative amount of operation of the photosensitive member 21 can be expressed by such a physical quantity as to monotonously increase or decrease as the operation history of this photosensitive member changes, and the total operating time, the cumulative number of revolutions, the cumulative number of images formed or the like can be, for example, used as such a physical quantity. These may be suitably combined. The look-up table 105 is referred based on the read-out amount of operation of the photosensitive member to determine the output voltage from the direct-current voltage generator 2325Y (Step S202).

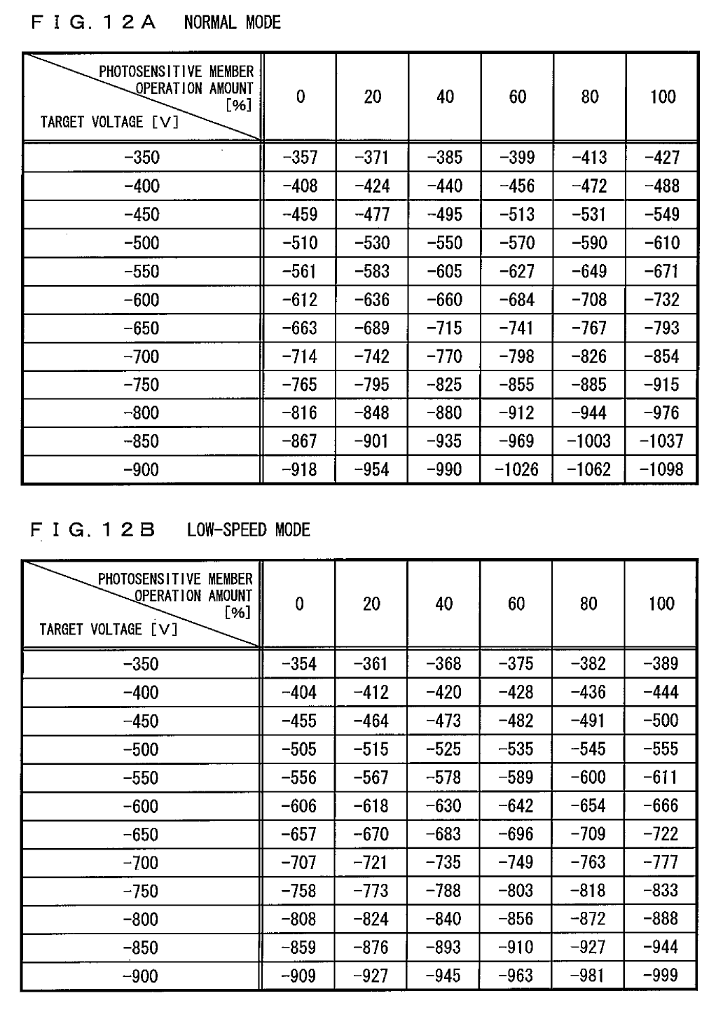

FIGS. 12A and 12B are charts showing examples of the look-up tables. More specifically, FIG. 12A shows a look-up table used upon executing a normal image forming operation (normal mode). FIG. 12B shows a look-up table used upon executing an image forming operation in a low-speed mode for executing the process at a low speed to form a finer image or to form an image on a thick recording material. In these look-up tables, the output voltage values of the direct-current voltage generator 2325Y corresponding to combinations of target voltages to be applied to the photosensitive member 21 and the cumulative amounts of operation of the photosensitive member (photosensitive member operation amounts) are formed into a table.

Here, the photosensitive member operation amount is expressed in percentage when the value of the operation amount regarded as its life is 100%. For example, the operation amount is estimated to be 0% when the photosensitive member is new while being estimated to be 100% when the cumulative amount of operation of the photosensitive member reaches the end of its designed lifetime. The target voltage is not constant, but suitably set within a specified variable range based on a temperature measurement result on room temperature and the result of a known density controlling operation that is not described.

In the look-up tables are written voltage values that are the sums of the target voltages to be applied to the photosensitive member 21 and voltages corresponding to voltage drops by the series resistor 2324Y disposed between the direct-current voltage generator 2325Y and the charging roller 231Y. The CPU 101 determines the voltage value written in the cell where the row of the voltage value to be applied to the photosensitive member 21 and the column of the photosensitive member operation amount at that time intersect as the output voltage of the direct-current voltage generator 2325Y at that time. By doing so, the direct-current voltage added with the voltage drop by the series resistor 2324Y is outputted from the direct-current voltage generator 2325Y, whereby the target voltage is applied to the charging roller 231Y.

Based on the knowledge that a charging current increases when the film thickness of the photosensitive member 21 decreases due to abrasion as the photosensitive member 21 is used, the table is generated such that the absolute value of the voltage increases, that is, the absolute value of the output voltage increases as the photosensitive member operation amount increases. In the low-speed mode in which the process speed is slow, an amount of electric charges injected to the photosensitive member 21 per unit time decreases because the operation of charging the photosensitive member 21 is executed at a lower speed, wherefore a charging current also becomes smaller. In view of this, in the table corresponding to the low-speed mode shown in FIG. 12B, the voltage drops by the series resistor 2324Y are estimated to be smaller than in the table corresponding to the normal mode shown in FIG. 12A.

Referring back to FIG. 11, the CPU 101 outputs a control signal corresponding to the output voltage thus determined to the multichannel DAC 102 (Step S203). By doing so, the direct-current voltage, which is the sum of the target voltage and the voltage drop by the series resistor 2324Y, is outputted from the direct-current voltage generator 2325Y, and a desired direct-current voltage, that is, the target voltage is applied to the charging roller 231Y.

After setting a state where the desired charging bias can be thus applied to the charging roller 231Y, the image forming station 2Y is caused to execute the image forming operation to form an image (Step S204). Upon completing the formation of the image, the operation amount of the photosensitive member 21 in this image forming operation is calculated and the cumulative operation amount stored in the RAM 104 is updated (Step S205).

As described above, in this embodiment, the direct-current voltages to be outputted from the respective direct-current voltage generators 2325Y, etc. are the sums of the target voltages to be applied to the charging rollers 231Y, etc. and the voltages equivalent to the voltage drops by the series resistors 2324Y, etc. connected to the voltage generators in series. Thus, the desired direct-current voltages can be applied to the respective charging rollers 231Y, etc. without being affected by the voltage drops caused by the series resistors.

In view of the fact that the charging currents increase as the photosensitive members 21 are used, the voltages corresponding to the voltage drops by the series resistors 2324Y, etc. are estimated to increase as the cumulative operation amounts of the photosensitive members 21 increase. More specifically, the look-up tables relating the cumulative operation amounts of the photosensitive members and the voltage values as the sums of the target voltages and the corresponding voltage drops are prepared beforehand, and the output voltages from the direct-current voltage generators are determined based on these look-up tables. By doing so, the voltage drop by the series resistor resulting from the charging current can be canceled even without having a construction for detecting the charging current, and a change of the charging current with time can be dealt with.

In this embodiment, the look-up table 105 corresponds to a “correction table” of the invention.

It should be noted that the invention is not limited to the embodiment above, but may be modified in various manners in addition to the embodiment above, to the extent not deviating from the object of the invention. For example, in the above embodiment, a bias generating circuit for applying a charging bias to the black image forming station 2K is provided independent from those for the other colors. However, the bias generating circuit may be commonly used for all the colors.

Further, upon executing the charging bias setting process, the output of the bias may be temporarily interrupted or the voltage may be switched while the bias is continuously outputted in the case of switching from the charging bias for image forming operation to the charging bias for test or vice versa. For example, the charging bias for forming an electrostatic latent image may be caused to function as a charging bias for test by delaying the application of this charging bias to a timing after the latent image is formed.

For example, the charging of the photosensitive member for forming an electrostatic latent image and the setting process may be simultaneously executed. In other words, while the photosensitive member is charged by applying the charging bias for forming the electrostatic latent image, the charging current flowing into the charging roller at this time may be detected, and the subsequent charging bias may be determined based on this detection result.

The image forming apparatuses of the above embodiment are so-called tandem-type image forming apparatuses in which four image forming stations each including the photosensitive member are arranged in a row in the moving direction of the transfer belt 81. However, the invention is also applicable to so-called rotary-type image forming apparatuses in which a plurality of developing devices are mounted in a rotatable development rotary and these are selectively positioned to face the photosensitive member for image formation.

Although the image forming apparatuses of the above embodiments are those including drum-shaped photosensitive members, belt-shaped photosensitive members may be, for example, used besides such drum-shaped photosensitive members as the electrostatic latent image carriers of the invention.

In the above embodiments, the invention is applied to the color image forming apparatuses using toners of four colors YMCK, the application subject of the invention is not limited to this and the invention is also applicable to image forming apparatuses dealing with different colors and different numbers of colors.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. An image forming apparatus, comprising:
a plurality of image forming stations each of which includes a photosensitive member and a charger that charges a surface of the photosensitive member to a specified surface potential, and is adapted to execute an image forming operation of forming an electrostatic latent image on the photosensitive member charged by the charger and developing the electrostatic latent image with toner to form an image;
a plurality of direct-current bias generators that are provided corresponding to the respective plurality of chargers and generate direct-current voltages as direct-current components of charging biases to be given to the chargers;
a plurality of series resistors that are provided corresponding to the respective plurality of chargers and electrically connect the plurality of chargers and the direct-current bias generators corresponding to the chargers in a one-to-one relationship;
an alternating-current bias generator that generates alternating-current voltages as alternating-current components of the charging biases to be given to the chargers; and
a controller that controls the voltage values of the direct-current voltages to be outputted from the respective direct-current bias generators, wherein
the direct-current voltage outputted from the direct-current bias generator corresponding to the charger via the series resistor corresponding to the charger and the alternating-current voltage outputted from the alternating-current bias generator are superimposed and applied as the charging bias to each of the plurality of chargers, and
the controller sets the voltage value of the direct-current voltage outputted from the direct-current bias generator to the sum of a target voltage preset as a voltage to be applied to the charger corresponding to the direct-current bias generator and a voltage drop caused by the series resistor corresponding to the charger and calculated based on a detection result on a direct current flowing into the charger for each of the direct-current bias generators.

2. The image forming apparatus according to claim 1, further comprising a current detector that individually detects the direct currents flowing into the respective chargers, wherein
the controller calculates voltage drops in the respective series resistor based on the detection results of the current detector.

3. The image forming apparatus according to claim 2, wherein
the current detector includes a plurality of current detecting resistors provided corresponding to the plurality of chargers, and
the respective plurality of current detecting resistors are disposed in series circuits including the chargers and the direct-current bias generators corresponding to the chargers.

4. The image forming apparatus according to claim 1, wherein the controller causes each direct-current bias generator to output a specified direct-current voltage for test and executes a setting process to set the voltage value of the direct-current voltage to be outputted from the direct-current bias generator based on the detection result on the direct current flowing into the charger corresponding to the direct-current bias generator at the time the specified direct-current voltage for test is outputted.

5. The image forming apparatus according to claim 4, wherein the alternating-current bias generator generates the same alternating-current voltage as in the execution of the image forming operation in the setting process.

6. The image forming apparatus according to claim 1, further comprising an image carrier that moves around in a specified direction, wherein
the plurality of image forming stations are arranged in the moving direction of the image carrier and respectively transfer toner images formed by executing the image forming operations to the image carrier at mutually different transfer positions.

7. The image forming apparatus according to claim 6, wherein the controller causes the respective direct-current bias generators to output specified direct-current voltages for test and executes setting processes to set the voltage values of the direct-current voltages to be outputted from the direct-current bias generators at mutually different timings based on the detection results on the direct currents flowing into the chargers corresponding to the direct-current bias generators at the times the specified direct-current voltages for test are outputted.

8. The image forming apparatus according to claim 7, wherein the controller executes the setting process for each direct-current bias generator when the image forming station including the charger corresponding to the direct-current bias generator is not executing the image forming operation.

9. The image forming apparatus according to claim 7, wherein the alternating-current bias generator generates the same alternating-current voltage as in the execution of the image forming operation in the setting process.

10. The image forming apparatus according to claim 1, further comprising, in addition to the plurality of image forming stations,
a single-operating image forming station that includes a single-operating photosensitive member and a single-operating charger for charging a surface of the single-operating photosensitive member to a specified surface potential, and is adapted to execute a single image forming operation of forming an electrostatic latent image on the surface of the single-operating photosensitive member charged by the single-operating charger and developing the electrostatic latent image to form a monochromatic image in a state where none of the plurality of image forming stations is operating, and
a single-operating bias generator that applies a charging bias generated by superimposing a direct-current voltage and an alternating-current voltage to the single-operating charger.

11. An image forming method, comprising:
charging a plurality of photosensitive members to specified surface potentials by chargers provided corresponding to the respective photosensitive members, forming electrostatic latent images and developing the electrostatic latent images with toners to form images,
providing a plurality of direct-current bias generators that generates direct-current voltages corresponding to the respective plurality of chargers,
applying charging biases to the respective chargers, the charging biases being generated by superimposing the direct-current voltages from the respective direct-current bias generators via series resistors on alternating-current voltages from an alternating-current bias generator that generates alternating-current voltages; and
setting a voltage value of the direct-current voltage outputted from the direct-current bias generator to a sum of a target voltage preset as a voltage to be applied to the charger corresponding to the direct-current bias generator and a voltage drop caused by the series resistor corresponding to the charger and calculated based on a detection result on a direct current flowing into the charger for each of the direct-current bias generators.

12. An image forming apparatus, comprising:
a plurality of image forming stations each of which includes a photosensitive member and a charger that charges a surface of the photosensitive member to a specified surface potential, and is adapted to execute an image forming operation of forming an electrostatic latent image on the photosensitive member charged by the charger and developing the electrostatic latent image with toner to form an image;
a plurality of direct-current bias generators that are provided corresponding to the respective plurality of chargers and generate direct-current voltages as direct-current components of charging biases to be given to the chargers;
a plurality of series resistors that are provided corresponding to the respective plurality of chargers and electrically connect the plurality of chargers and the direct-current bias generators corresponding to the chargers in a one-to-one relationship;
an alternating-current bias generator that generates alternating-current voltages as alternating-current components of the charging biases to be given to the chargers; and
a controller that controls the voltage values of the direct-current voltages to be outputted from the respective direct-current bias generators, wherein
the direct-current voltage outputted from the direct-current bias generator corresponding to the charger via the series resistor corresponding to the charger and the alternating-current voltage outputted from the alternating-current bias generator are superimposed and applied as the charging bias to each of the plurality of chargers,
the controller sets a voltage value of the direct-current voltage outputted from the direct-current bias generator to a sum of a target voltage preset as a voltage to be applied to the charger corresponding to the direct-current bias generator and a voltage value equivalent to a voltage drop caused by the series resistor corresponding to the charger due to a direct current flowing into the charger for each of the direct-current bias generators, and
the controller corrects the voltage value equivalent to the voltage drop according to an operation history of the photosensitive member charged by the charger corresponding to the direct-current bias generator.

13. The image forming apparatus according to claim 12, wherein the controller includes, in advance, a correction table relating the operation histories of the photosensitive members to the output voltages of the corresponding direct-current bias generators, and sets the output voltage values of the direct-current bias generators based on the correction table.

14. The image forming apparatus according to claim 12, wherein the controller determines the operation history of each photosensitive member based on an operating time thereof.

15. The image forming apparatus according to claim 12, wherein the controller determines the operation history of each photosensitive member based on a number of images that have been formed.

16. The image forming apparatus according to claim 12, wherein
each image forming station can selectively execute a plurality of operation modes having different process speeds as the image forming operation, and
the controller causes a correction amount in the correction to differ depending on the operation mode.

17. The image forming apparatus according to claim 12, wherein the controller increases an absolute value of the output voltage of the direct-current bias generator as an operation amount of the photosensitive member which is calculated based on the operation history increases.

18. The image forming apparatus according to claim 12, further comprising, in addition to the plurality of image forming stations,
a single-operating image forming station that includes a single-operating photosensitive member and a single-operating charger for charging a surface of the single-operating photosensitive member to a specified surface potential, and is adapted to execute a single image forming operation of forming an electrostatic latent image on the surface of the single-operating photosensitive member charged by the single-operating charger and developing the electrostatic latent image to form a monochromatic image in a state where none of the plurality of image forming stations is operating, and
a single-operating bias generator that applies a charging bias generated by superimposing a direct-current voltage and an alternating-current voltage to the single-operating charger.

19. An image forming method, comprising:
charging a plurality of photosensitive members to specified surface potentials by chargers provided corresponding to the respective photosensitive members, forming electrostatic latent images and developing the electrostatic latent images with toners to form images,
providing a plurality of direct-current bias generators that generates direct-current voltages corresponding to the respective plurality of chargers,
applying charging biases to the respective chargers, the charging biases being generated by superimposing the direct-current voltages from the respective direct-current bias generators via series resistors on alternating-current voltages from an alternating-current bias generator that generates alternating-current voltages; and
setting a voltage value of the direct-current voltage outputted from the direct-current bias generator to a sum of a target voltage preset as a voltage to be applied to the charger corresponding to the direct-current bias generator and a voltage value equivalent to a voltage drop caused by the series resistor corresponding to the charger due to a direct current flowing into the charger for each of the direct-current bias generators; and
correcting the voltage value equivalent to the voltage drop according to an operation history of the photosensitive member charged by the charger corresponding to the direct-current bias generator.
